(19) United States
(12) Patent Application Publication
(10) Pub. No.: US 2024/0045230 A1
(43) Pub. Date: Feb. 8, 2024

(54) EYEGLASSES WITH QUICK-CHANGE LENS

(71) Applicant: York TSAI, New Taipei City (TW)

(72) Inventor: York TSAI, New Taipei City (TW)

(21) Appl. No.: 18/350,422

(22) Filed: Jul. 11, 2023

(30) Foreign Application Priority Data
Aug. 3, 2022 (TW) 111208352

(51) Int. Cl. G02C 5/22

(52) U.S. Cl. CPC G02C 5/2281

(57) ABSTRACT

A pair of eyeglasses includes a lens body having two engaging grooves formed in left and right sides thereof and respectively having an engaging section, and two quick release mechanisms detachably disposed on the left and right sides of the lens body and each including a positioning member defining a positioning slot and a receiving hole, an engaging member detachably engaged to the engaging section of a respective engaging groove and having a slide piece portion and a stop block portion, and a connecting member disposed on rear sides of the positioning member and the engaging member. When the engaging member of each quick release mechanism is pressed into the positioning member, the slide piece portion is located in the positioning slot and the stop block portion is received in the receiving hole to allow detachment of each quick release mechanism from the lens body.

### CROSS-REFERENCE TO RELATED APPLICATION

This application claims priority to Taiwanese Utility Model Patent Application No. 111208352, filed on Aug. 3, 2022.

### FIELD

The present disclosure relates to a pair of eyeglasses, and more particularly to a pair of eyeglasses having a lens that can be quickly removed and replaced.

### BACKGROUND

Referring to FIG. 1, a pair of eyeglasses 1 with a replaceable lens, as disclosed in Taiwanese Patent Publication No. 202132864, includes a glass frame 11, a lens 12 disposed under the glass frame 11, and a lens frame 13 detachably mounted to a lower end of the lens 12. The lens 12 has a plurality of outwardly protruding protrusions 121. The lens frame 13 has an embedded groove 131 opening upwardly and configured to correspond to the lower end of the lens 12, and a plurality of engaging grooves 132 located in the embedded groove 131 and respectively corresponding to the protrusions 121. During assembly of the eyeglasses 1, the lens 12 is first disposed under the glass frame 11, after which the lens 12 is aligned with and then inserted into the embedded groove 131 of the lens frame 13, and the protrusions 121 are engaged respectively with the engaging grooves 132, thereby assembling the lens frame 13 to the lens 12.

Although the eyeglasses 1 can be replaced with different lenses 12 or lens frames 13 of different functions to meet the requirements of sun protection, safety, and special appearance, in order to stably connect the lens frame 13 to the lens 12, the number of the protrusions 121 must often be more than four. Thus, it is necessary to apply multiple forces to complete the engagement of the protrusions 121 with the respective engaging grooves 132. Hence, the assembly steps of the aforesaid eyeglasses 1 are complicated and difficult to operate.

Furthermore, to remove the lens 12 of the eyeglasses 1, it is also necessary to apply a large external force so as to deform the lens frame 13 to a certain degree, and only then can the protrusions 121 be disengaged from the respective engaging grooves 132. Thus, during application of the external force, it may easily cause accidental damage to the lens frame 13 or the lens 12. Moreover, if the operation of changing the lens 12 is taken as an example, after the lens frame 13 is removed from the lens 12, it is also necessary to remove the lens 12 from the glass frame 11, and only then can the lens 12 be replaced relative to the glass frame 11 and the lens frame 13 that match each other. Hence, the replacement steps of the aforesaid eyeglasses 1 are also complicated and difficult to operate.

### SUMMARY

Therefore, an object of the present disclosure is to provide a pair of eyeglasses that can alleviate at least one of the drawbacks of the prior art.

According to this disclosure, the pair of eyeglasses includes a lens, two quick release mechanisms, and two temples. The lens has a lens body, and two engaging grooves respectively formed in left and right sides of the lens body. Each engaging groove has an engaging section in the form of a circular hole, and an opening section extending rearwardly from and communicating with the engaging section. The opening section has a width measured in a top-bottom direction smaller than an inner diameter of the engaging section.

The quick release mechanisms are respectively and detachably disposed on the left and right sides of the lens body. Each quick release mechanism includes a positioning member, an engaging member, and a connecting member. The positioning member defines a positioning slot for insertion of a respective one of the left and right sides of the lens body therein, and a receiving hole located inwardly of and communicating with the positioning slot. The engaging member is disposed in the positioning member, is detachably engaged to the engaging section of a respective engaging groove, and has a slide piece portion with a maximum width measured in the top-bottom direction smaller than the width of the opening section, and a stop block portion connected to an inner side of the slide piece portion and having an outer diameter larger than the width of the opening section but smaller than or equal to the inner diameter of the engaging section. The stop block portion has two slide surfaces inclined forwardly and downwardly therefrom. The connecting member is disposed on rear sides of the positioning member and the engaging member.

The temples are respectively connected to rear ends of the connecting members of the quick release mechanisms.

Each engaging groove and the stop block portion of the engaging member of each quick release mechanism are located in the positioning slot of the positioning member of a corresponding one of the quick release mechanisms. When the engaging member of each quick release mechanism is pressed into the positioning member, the slide piece portion is located in the positioning slot and the stop block portion is received in the receiving hole to allow detachment of each quick release mechanism from the lens body.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is an exploded perspective view of a pair of eyeglasses disclosed in Taiwanese Patent Publication No. 202132864.

FIG. 2 is a perspective view of a pair of eyeglasses according to the first embodiment of the present disclosure.

FIG. 3 is a partly exploded perspective view of the first embodiment.

FIG. 4 is a perspective view of a positioning member of a quick release mechanism of the first embodiment.

FIG. 5 is a perspective view of an engaging member of the quick release mechanism of the first embodiment.

FIG. 6 is a view similar to FIG. 5, but taken from another angle, further illustrating the structure of the engaging member.

FIG. 7 is a fragmentary exploded perspective view, illustrating an assembly relationship between a temple and a connecting member of the quick release mechanism.

FIG. 8 is a fragmentary sectional top view, illustrating a configuration between the positioning member and the engaging member of the quick release mechanism.

FIG. 9 is an enlarged fragmentary sectional side view, illustrating a situation in which the engaging member is engaged to the lens.

FIG. 10 is a view similar to FIG. 9, but illustrating a situation in which the engaging member is pressed to disengage from the lens.

FIG. 11 is a view similar to FIG. 9, but illustrating how the quick release mechanism can be quickly assembled to the lens.

FIG. 12 is an exploded perspective view of a pair of eyeglasses according to the second embodiment of the present disclosure, but without the temples.

FIG. 13 is a sectional side view, illustrating the positioning member and the engaging member of the quick release mechanism of the second embodiment.

FIG. 14 is a partial sectional view, further illustrating the engaging member in FIG. 13.

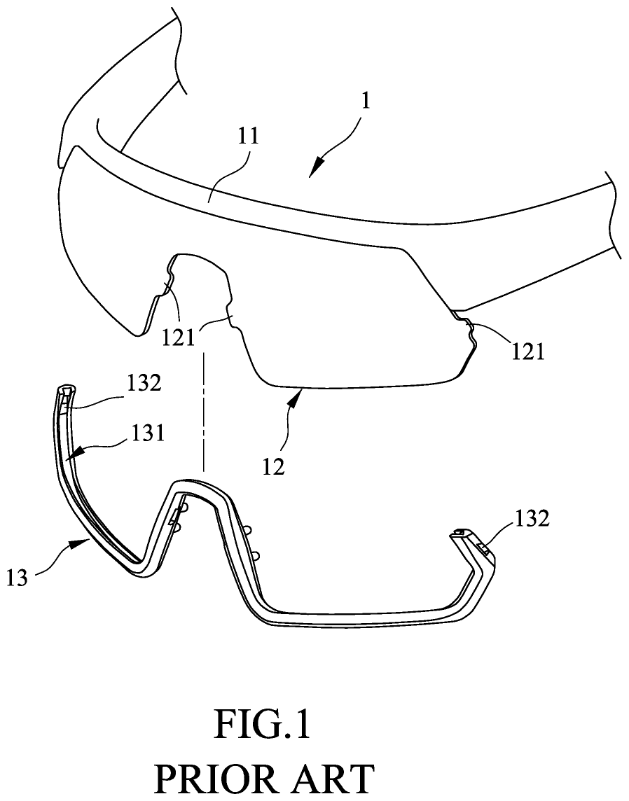

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. It should be noted that, for the sake of illustration, the directional references, such as up, down, left, right, inside, outside, front and rear, are intended to be relative to the orientation of a wearer wearing the eyeglasses.

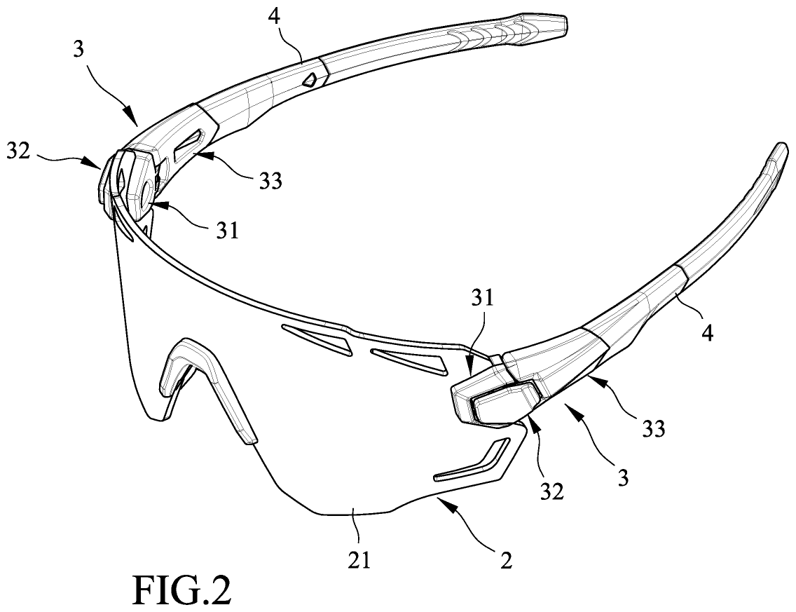

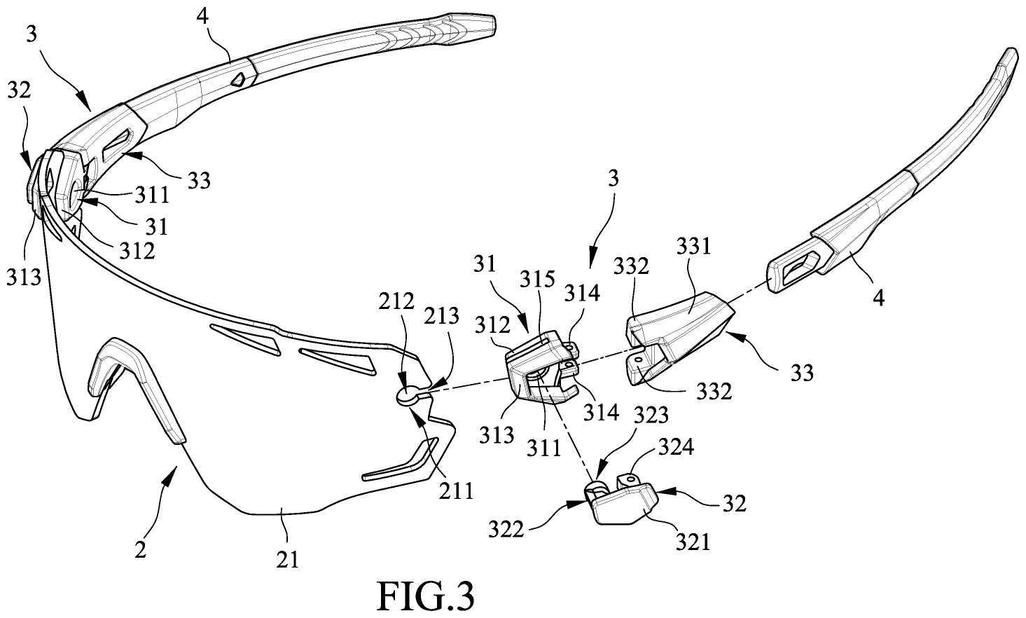

Referring to FIGS. 2 and 3, a pair of eyeglasses according to the first embodiment of the present disclosure is shown to include a lens 2, two quick release mechanisms 3, and two temples 4.

The lens 2 has a lens body 21, and two engaging grooves 211 respectively formed in left and right sides of the lens body 21. Each engaging groove 211 has an engaging section 212 in the form of a circular hole, and an opening section 213 extending rearwardly from and communicating with the engaging section 212. The opening section 213 has a width measured in a top-bottom direction smaller than an inner diameter of the engaging section 212.

The quick release mechanisms 3 are respectively and detachably disposed on left and right sides of the lens body 21. Each quick release mechanism 3 includes a positioning member 31, an engaging member 32 pivotally disposed in the positioning member 31, and a connecting member 33 pivoted to rear sides of the positioning member 31 and the engaging member 32.

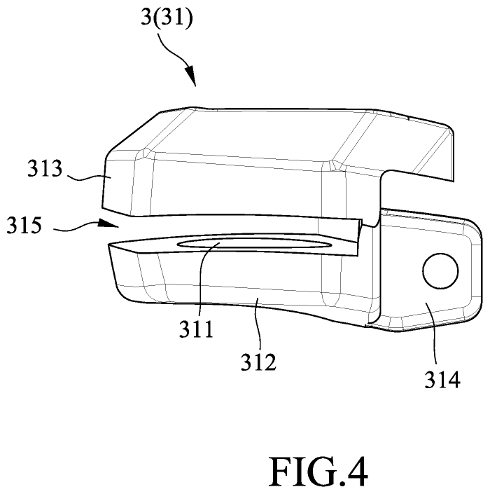

Referring to FIG. 4, in combination with FIGS. 2 and 3, the positioning member 31 has an inner frame portion 312 defining a receiving hole 311 in the form of a through hole, an outer frame portion 313 of substantially U-shape connected to an outer side of the inner frame portion 312, and two pivot lugs 314 extending rearwardly from the inner frame portion 312 and spaced apart from each other in a top-bottom direction. The inner and outer frame portions 312, 313 cooperatively define a positioning slot 315 located outwardly of and communicating with the receiving hole 311.

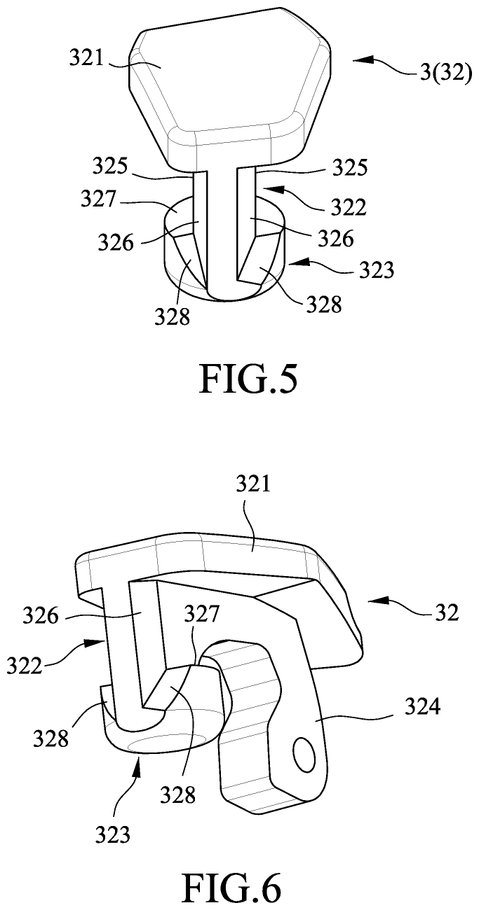

Referring to FIGS. 5 and 6, in combination with FIG. 3, the engaging member 32 has a main wall portion 321 extending in a front-rear direction and located slightly out of the outer frame portion 313 in a left-right direction, a slide piece portion 322 of substantially L-shape extending inwardly from the main wall portion 321 into the outer frame portion 313 and having a long side connected to the main wall portion 321 and a short side extending from the long side in a direction away from the main wall portion 321, a stop block portion 323 connected to the short side of the slide piece portion 322, and a pivot arm portion 324 that extends inwardly from the main wall portion 321 into the outer frame portion 313, that is located rearwardly of the stop block portion 323 and the slide piece portion 322, that is connected to an end of the long side of the slide piece portion 322 opposite to the short side thereof, and that is pivotally disposed between the pivot lugs 314 such that the pivot lugs 314 are respectively located on top and bottom sides of the pivot arm portion 324. The slide piece portion 322 has two lateral surfaces 325 spaced apart from each other in the top-bottom direction, and two tapered surfaces 326 respectively connected to front ends of the lateral surfaces 325 and tapering toward each other in a rear-to-front direction. A distance between the lateral surfaces 325 is the maximum width of the slide piece portion 322 measured in the top-bottom direction which is smaller than the width of the opening section 213. The stop block portion 323 has an outer diameter smaller than or equal to the inner diameter of the engaging section 212, but larger than the width of the opening section 213. The stop block portion 323 has a surrounding surface 327 connected to the lateral surfaces 325 of the slide block portion 322 and facing the main wall portion 321, and two slide surfaces 328 inclined forwardly and downwardly from two opposite ends of the surrounding surface 327 and respectively having inner ends connected to the tapered surfaces 326.

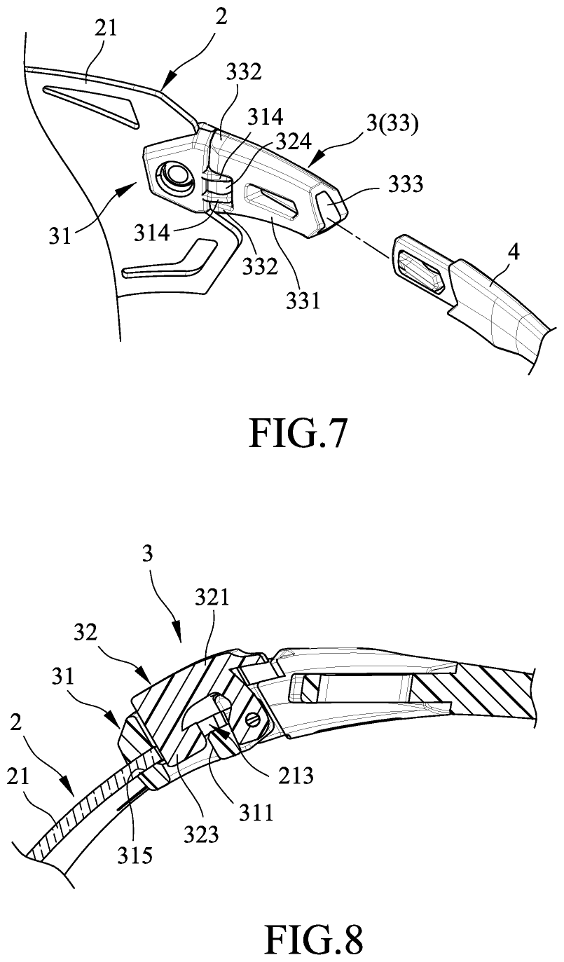

Referring to FIG. 7, in combination with FIG. 3, the connecting member 33 includes a main body portion 331 located rearwardly of the positioning member 31 and the engaging member 32, and two spaced-apart pivot portions 332 extending forwardly from the main body portion 331. The main body portion 331 is formed with an insertion groove 333 extending inwardly from a rear end thereof for insertion of a respective one of the temples 4 therein. That is, the temples 4 are respectively connected to rear ends of the connecting members 33 of the quick release mechanisms 3. Each temple 4 can be fixed in the insertion groove 333 of the main body portion 331 of the connecting member 33 of the respective quick release mechanism 3 by a tight fitting engagement or by adhesion. The pivot portions 332 are respectively located on top of a top one of the pivot lugs 314 and bottom of a bottom one of the pivot lugs 314, that is, each pivot lug 314 is located between the pivot arm portion 324 and a corresponding one of the pivot portions 332. The pivot portions 332 are coaxially pivotally connected to the pivot lugs 314 and the pivot arm portion 324.

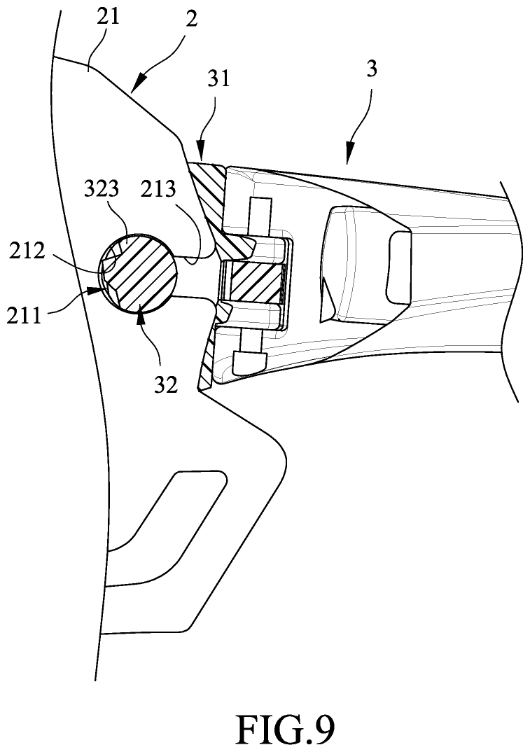

Use of the first embodiment will be described hereinafter. Referring to FIGS. 8 and 9, in combination with FIGS. 3 and 4, when each quick release mechanism 3 is fixed to the respective left or right side of the lens body 21, the engaging groove 211 in the left or right side of the lens body 21 is located in the positioning slot 315, and the stop block portion 323 is engaged with the engaging section 212. Since the outer diameter of the stop block portion 323 is larger than the width of the opening section 213, each quick release mechanism 3 is fixed to the respective left or right side of the lens body 21 through the stop block portion 323 thereof and cannot be easily removed therefrom.

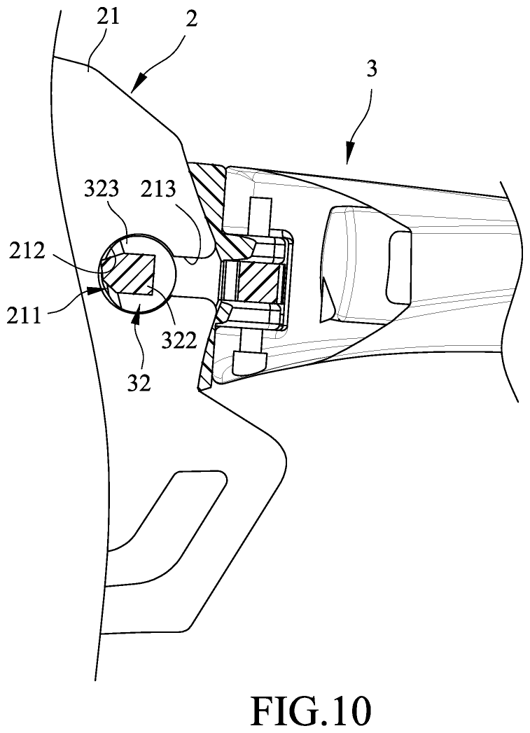

Referring to FIG. 10, in combination with FIGS. 3 and 8, when it is desired to detach and remove the quick release mechanism 3 from the left side of the lens body 21, the main wall portion 321 of the engaging member 32 of the quick release mechanism 3 is pressed inwardly, and through a slight deformation of the slide piece portion 322, the slide piece portion 322 and the stop block portion 323 can move inwardly relative to the positioning slot 315, so that the slide piece portion 322 is located in the positioning slot 315, and the stop block portion 323 is received in the receiving hole 311. At this time, since the maximum width of the slide piece portion 322 is smaller than the width of the opening section 213, a user can pull the quick release mechanism 3 rearwardly so as to move the slide piece portion 322 out of the engaging groove 211 through the opening section 213, thereby removing the quick release mechanism 3 together with the temple 4 from the lens 2. Finally, by repeating the aforesaid steps, the other quick release mechanism 3 can also be detached and removed from the right side of the lens body 21. Hence, the effect of quickly disassembling each quick release mechanism 3 from the respective left or right side of the lens body 21 of the lens 2 can be achieved.

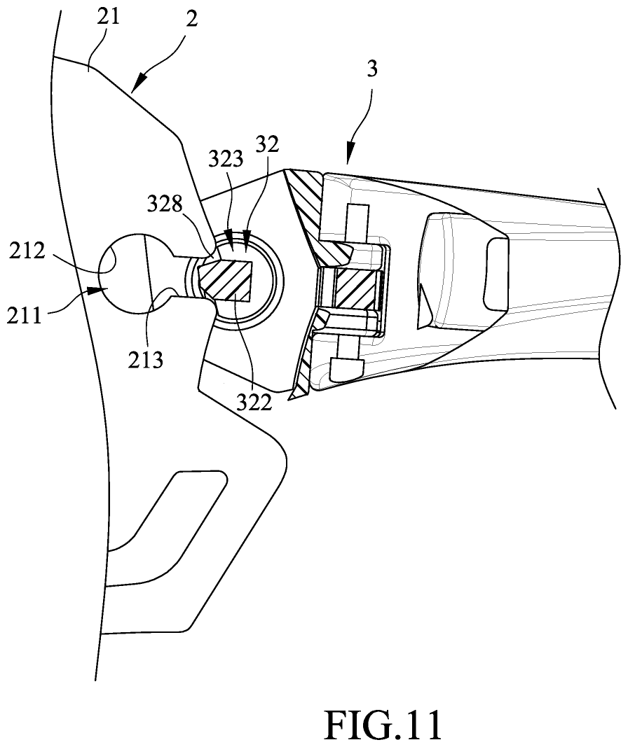

Referring to FIG. 11, in combination with FIGS. 3 and 5, when it is desired to mount any one of the quick release mechanisms 3 onto the lens 2, there is no need to press the main wall portion 321 of the engaging member 32 of the quick release mechanism 3, but it is only necessary to align the positioning slot 315 with the engaging groove 211, after which the quick release mechanism 3 is pushed forwardly so as to abut the slide surfaces 328 of the stop block portion 323 located in the positioning slot 315 against an inner side of the opening section 213 of the engaging groove 211. Next, when the user continues to push the quick release mechanism 3 forwardly, the slide surfaces 328 will move gradually, forwardly and inclinedly relative to the opening section 213, and drive the stop block portion 323 together with the slide piece portion 322 to move forwardly therealong, thereby allowing a portion of the engaging member 32 to deform so that the stop block portion 323 can enter the receiving hole 311 and the slide piece portion 322 can be located in the positioning slot 315. As the user continues to push the quick release mechanism 3, the slide piece portion 322 can enter the engaging section 212 through the opening section 213. When the slide surfaces 328 no longer abut against the inner side of the opening section 213, the engaging member 32 will restore to its original shape due to the elasticity of the material thereof, and the stop block portion 323 will enter the engaging section 212 to produce a fixing effect. At this time, the slide piece portion 322 is located in the outer frame portion 313. Since the slide surfaces 328 are disposed forwardly of the stop block portion 323, after the stop block portion 323 enters the engaging section 212, the quick release mechanism 3 cannot be removed from the lens 2 by simply pulling the quick release mechanism 3 rearwardly, so that the quick release mechanism 3 can be prevented from accidentally detaching from the lens 2. Thus, safety and convenience can be ensured simultaneously.

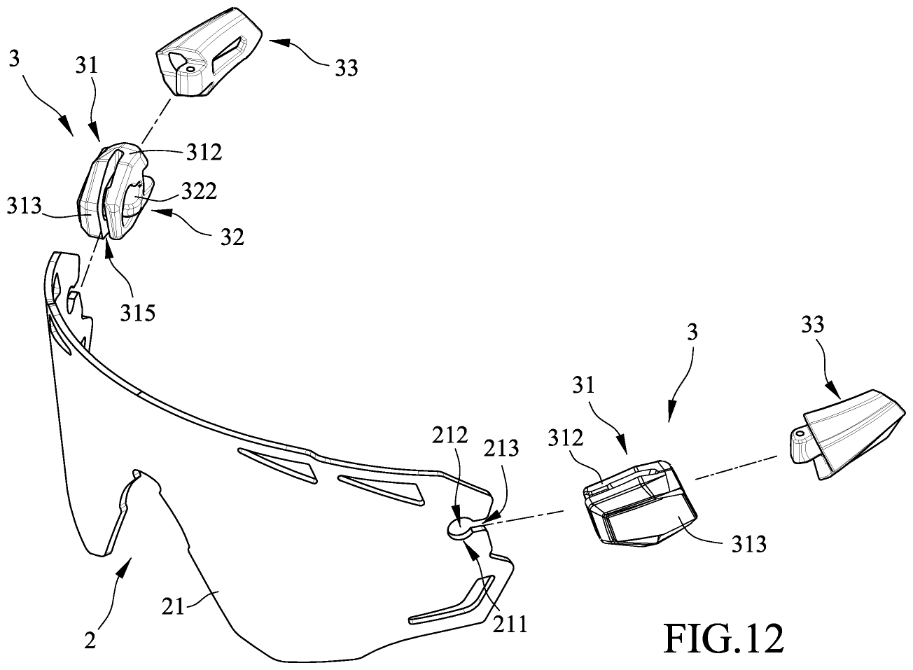

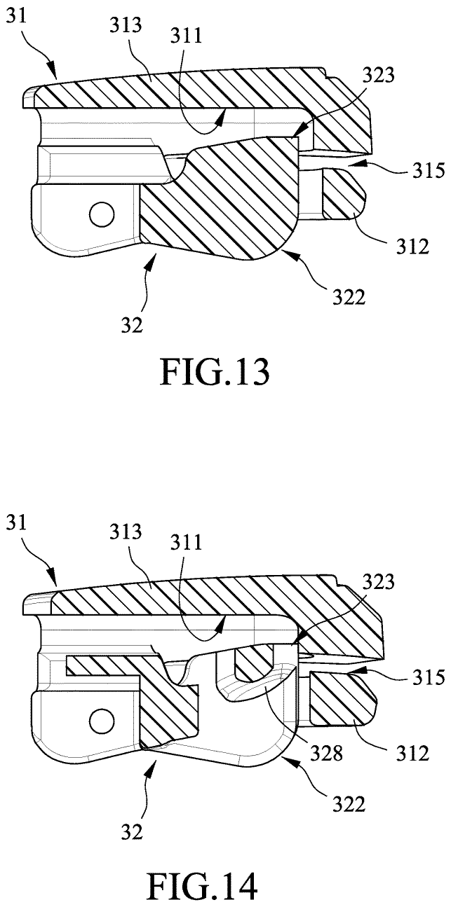

Referring to FIGS. 12 to 14, a pair of eyeglasses according to the second embodiment of the present disclosure is shown to be generally identical to the first embodiment, and differs in that, in the second embodiment, the positioning member 31 and the engaging member 32 of each quick release mechanism 3 are integrally formed as one piece, the slide piece portion 322 of the engaging member 32 is directly connected to the inner frame portion 312, and the receiving hole 311 of the positioning member 31 is defined by the outer frame portion 313 and does not extend therethrough.

When it is desired to mount any one of the quick release mechanisms 3 of the second embodiment onto the lens 2, the positioning slot 315 of the quick release mechanism 3 is likewise aligned with the engaging groove 211, after which the quick release mechanism 3 is pushed forwardly. Next, through the inclined movement of the slide surfaces 328 relative to the inner side of the opening section 213 of the engaging groove 211, the stop block portion 323 together with the slide piece portion 322 are driven to move forwardly therealong, thereby allowing a portion of the engaging member 32 to deform, so that the stop block portion 323 can enter the receiving hole 311 and the slide piece portion 322 can be located in the positioning slot 315. As the user continues to push the quick release mechanism 3, the slide piece portion 322 can enter the engaging section 212 through the opening section 213. When the slide surfaces 328 no longer abut against the inner side of the opening section 213, the engaging member 32 will restore to its original shape due to the elasticity of the material thereof, and the stop block portion 323 will enter the engaging section 212 to produce a fixing effect. When it is desired by the user to disassemble the lens 2, the slide piece portion 322 is simply pressed from the inside to the outside to separate the lens 2 from the corresponding quick release mechanism 3. Thus, the second embodiment provides an integrated form of the positioning member 31 and the engaging member 32 so as to provide consumers with more diverse options.

In summary, in the eyeglasses of the present disclosure, by pressing the main wall portion 321 and then pulling rearwardly the quick release mechanism 3, each quick release mechanism 3 can be quickly separated from the lens 2; and, to mount each quick release mechanism 3 onto the lens 2, it is only necessary to push each quick release mechanism 3 forwardly onto the lens 2, and it can be ensured that the quick release mechanisms 3 cannot be removed from the lens 2 by simply pulling them rearward, so that the stability of mounting, safety, and quick replacement can be obtained. Therefore, the object of this disclosure can indeed be achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pair of eyeglasses, comprising:
a lens having a lens body, and two engaging grooves respectively formed in left and right sides of said lens body, each of said engaging grooves having an engaging section in the form of a circular hole, and an opening section extending rearwardly from and communicating with said engaging section, said opening section having a width measured in a top-bottom direction smaller than an inner diameter of said engaging section;
two quick release mechanisms respectively and detachably disposed on said left and right sides of said lens body, each of said quick release mechanisms including
a positioning member defining a positioning slot for insertion of a respective one of said left and right sides of said lens body therein, and a receiving hole located inwardly of and communicating with said positioning slot,
an engaging member disposed in said positioning member and detachably engaged to said engaging section of a respective one of said engaging grooves, said engaging member having a slide piece portion with a maximum width measured in the top-bottom direction smaller than said width of said opening section, and a stop block portion connected to an inner side of said slide piece portion and having an outer diameter larger than said width of said opening section but smaller than or equal to said inner diameter of said engaging section, said stop block portion having two slide surfaces that are inclined forwardly and downwardly therefrom, and
a connecting member disposed on rear sides of said positioning member and said engaging member; and
two temples respectively connected to rear ends of said connecting members of said quick release mechanisms wherein each of said engaging grooves and said stop block portion of said engaging member of each of said quick release mechanisms are located in said positioning slot of said positioning member of a corresponding one of said quick release mechanisms; and
wherein, when said engaging member of each of said quick release mechanisms is pressed into said positioning member, said slide piece portion is located in said positioning slot and said stop block portion is received in said receiving hole to allow detachment of each of said quick release mechanisms from said lens body.

2. The pair of eyeglasses as claimed in claim 1, wherein said engaging member of each of said quick release mechanisms further has a main wall portion connected to said slide piece portion, and a pivot arm portion that is located rearwardly of said stop block portion and said slide piece portion, that extends inwardly from said main wall portion and that is pivotally disposed in said positioning member.

3. The pair of eyeglasses as claimed in claim 2, wherein said positioning member of each of said quick release mechanisms has an inner frame portion defining said receiving hole, an outer frame portion connected to an outer side of said inner frame portion and surrounding said engaging member, and two pivot lugs that extend rearwardly from said inner frame portion, that are respectively located at top and bottom sides of said pivot arm portion, and that are pivoted to said pivot arm portion, said outer frame portion and said inner frame portion cooperatively defining said positioning slot.

4. The pair of eyeglasses as claimed in claim 3, wherein said slide piece portion of said engaging member has two lateral surfaces spaced apart from each other in the top-bottom direction, and two tapered surfaces respectively connected to front ends of said lateral surfaces and tapering toward each other in a rear-to-front direction.

5. The pair of eyeglasses as claimed in claim 4, wherein said stop block portion of said engaging member has a surrounding surface connected to said lateral surfaces of said slide piece portion and facing said main wall portion, said slide surfaces being inclined forwardly and downwardly from two opposite ends of said surrounding surface and respectively having inner ends connected to said tapered surfaces.

6. The pair of eyeglasses as claimed in claim 3, wherein said connecting member of each of said quick release mechanisms includes a main body portion located rearwardly of said positioning member and said engaging member, and two spaced-apart pivot portions extending forwardly from said main body portion and coaxially pivotally connected to said pivot lugs of said positioning member and said pivot arm portion of said engaging member, said main body portion being formed with an insertion groove extending inwardly from a rear end thereof for insertion of a respective one of said temples therein.

7. The pair of eyeglasses as claimed in claim 1, wherein said positioning member and said engaging member of each of said quick release mechanisms are integrally connected to each other, and said slide piece portion of said engaging member is connected to said positioning member.
